(19) United States
(12) Patent Application Publication
(10) Pub. No.: US 2005/0069041 A1
(43) Pub. Date: Mar. 31, 2005

(54) Coherent expandable high speed interface

(76) Inventor: Daniel J. Lincoln, Bowie, MD (US)

Correspondence Address: LUEDEKA, NEELY & GRAHAM, P.C., P O BOX 1871, KNOXVILLE, TN, 37901, US

(21) Appl. No.: 10/988,934

(22) Filed: Nov. 15, 2004

Related U.S. Application Data
(63) Continuation of application No. 09/680,625, filed on Oct. 6, 2000.

(51) Int. Cl. H04B 3/00

(52) U.S. Cl. 375/257

(57) ABSTRACT

A method and apparatus is provided for passing an N bit wide data stream between two physical devices at high speed while maintaining the coherency of the data streams during the transfer. The N bit wide data stream is transmitted in N parallel data streams on N of N+1 differential data lines. A predetermined serial sync detect pattern is transferred on the remaining differential data line, which is designated as the sync line. A sub interval clock phase is then determined for the sync line that will successfully extract the transmitted sync detect pattern during each half cycle of the clock. This sub interval clock phase compensates for differing delays in the data streams across the physical interface. All of the N+1 differential data lines are in turn designated as the sync line to determine a sub interval clock phase for each of the respective differential data lines. Data is then extracted from the N data streams by sampling at the sub interval clock phase determined for each particular data line. The number of clock cycles that pass between reception of the sync detect pattern on the sync line and reception of the sync detect pattern on the next data line designated as the sync line is counted. The counted number of clock cycles is then compared to a predetermined number of clock cycles that pass between transmission of the sync detect pattern on the respective lines to determine if any data skew of multiple clock cycles is present between the respective lines. Any detected data skew is corrected. Thus, the present invention provides an improved method and apparatus for transmitting continuous parallel data streams while the bits in the data streams maintain their relative positions when received.

This application is a continuation of U.S. patent application Ser. No. 09/680,625 filed Oct. 6, 2000, entitled COHERENT EXPANDABLE HIGH SPEED INTERFACE.

### FIELD OF THE INVENTION

The present invention relates generally to a high speed interface for passing an N bit wide data stream between two physical devices while maintaining the coherency of the data. More particularly, the invention relates to a method and system which determines and accounts for line and other related circuit architectural delays to ultimately synchronize data at the receiver end during chip-to-chip communications.

### BACKGROUND OF THE INVENTION

Modem digital computers and communications equipment are being designed to operate at ever higher data rates. As data rates approach speeds around 1 Gbit per second, time delays and phase shifts become more pronounced. In particular, when data streams are transmitted in parallel between two devices at high speeds, differences in the transfer characteristics of the parallel data lines may result in some data bits arriving later or earlier than other corresponding data bits. This shifting of the data bits is commonly referred to as skew. The skew or time delaying and phase shifting of the data may cause the original data bits to change their relative positions such that the coherency of the original data is lost. In fact, if the data speeds are high enough and the differences in the line characteristics are large enough, the delays between corresponding data bits can be as large as several clock cycles.

A variety of different approaches have been created to deal with the skewing of data between source and destination to maintain the coherence of the data across a data bus. However, as the bus becomes wider and the frequency higher, prior art systems incur major penalties in the context of bus width, the need for very critical physical layouts, special cell requirements, high chip physical area requirements and significant power consumption. Therefore, what is needed is a method and system for insuring the coherence of data bits being transferred at high speeds between two physical devices which can be easily expanded to accommodate large numbers of parallel data lines and different technologies.

### SUMMARY OF THE INVENTION

The present invention is designed to address the above discussed problems with the prior art by providing an improved method for interface connection in passing a coherent multiple bit wide data stream between a transmitting device and receiving device. In accordance with the method, a clock signal is produced at the transmitting device and transmitted to the receiving device. A predetermined synchronization pattern is sent from the transmitting device to the receiving device on each of the multiple data lines of the interface connection. A sub interval clock phase is then determined that will successfully compensate for phase delays associated with each of the data lines and thus extract the synchronization pattern from each data line. The sub interval clock phased sample is then applied to the data streams received by the receiving device on each of the data lines to compensate for the phase delays.

In accordance with a preferred embodiment, the method also determines a bit delay between a received data stream on one of the multiple data lines designated as a reference delay line and a received data stream on each of the multiple data lines not designated as the reference delay line. The received data streams are then skew corrected according to their respective delays such that the data streams are coherently transferred between the transmitting device and the receiving device.

In the above described method, the clock signal and the data streams are preferably transmitted on differential sets of signal lines. Differential pairs of data lines are used for high speed communications and allow the data to be transmitted at high speeds in a bi-phase manner such that even bits are transmitted during high clock output states and odd bits are transmitted during low clock output states. In such an embodiment, determining a sub interval clock phase further includes determining both a first sub interval clock phase for a high clock output state half cycle and a second sub interval clock phase for a low clock output state half cycle. The synchronization pattern in such an embodiment also includes a first phase synchronization pattern and a second phase synchronization pattern. The first sub interval clock phase is applied to data received during high clock output state half cycles and the second sub interval clock phase is applied to data received during low clock output state half cycles.

The above method determines and corrects phase delays for each individual data line. In addition, the method allows phase delay determination and correction to take place in real time without interrupting the transmission of the data streams. Furthermore, the method requires relatively little circuitry and can be easily expanded to work with large numbers of parallel data streams without dramatically increasing the amount of circuitry required.

Another especially preferred embodiment of the above described method further determines a bit delay between a received data stream on one of the data lines designated as a reference delay line and the received data stream on each of the other data lines which are not designated as the reference delay line. The received data streams are then skewed by their respective bit delays such that the data streams are coherently transferred between the transmitting device and the receiving device. Thus, the relative bit positions between the data streams are maintained between the transmitting and receiving devices.

The above described embodiment corrects for both phase delays and whole bit delays. The data being transmitted over one of the parallel data streams may be related to the data being transmitted over the other parallel data lines. In such a situation, failure to account for delays of a whole bit or multiple bits, may corrupt the data by destroying its coherency. Thus, the above described preferred embodiment helps maintain the coherency of the data.

The present invention is also directed toward an interface for maintaining the coherency of bi-phase data in N data streams being transmitted between a transmitting device and receiving device. This interface includes a transmitting device interface and a receiving device interface. A sync pattern provider located on the transmitting device interface provides a predetermined sync detect pattern having a first phase sync detect pattern and a second phase sync detect pattern. A clock generator transmits a clock signal having a first clock phase period and a second clock phase period at the transmitting device. A sync multiplexer that is located at the transmitting device interface receives the N data streams from the transmitting device and the sync detect pattern from the sync pattern provider and selectively multiplexes the synch detect pattern and the N data streams onto the N+1 data lines. The sync pattern provider is an M bit serial shift register that serially provides an M bit sync detect pattern to the sync multiplexer in response to the clock signal. A controller designates one of the N+1 data lines as a sync detect line and designates N of the N+1 data lines as data transmitting lines. The sync multiplexer transmits the sync detect pattern to the receiving device interface on a selected sync detect line and transmits the N data streams to the receiving device interface on each one of the N+1 data lines not selected as the sync detect line.

N+1 samplers are positioned at the receiving device interface for receiving and sampling the N data streams and the sync detect pattern on the N+1 data lines. The N+1 samplers sample a data stream at multiple phase time delays to produce first phase test patterns and subsequently sample the data stream at multiple phase time delays to produce multiple second phase test patterns. A comparator compares each one of the multiple sampled phase test patterns to the first phase sync detect pattern to determine if any are equivalent to the first phase sync detect pattern and designates one or more specific first phase test patterns as selected first phase test patterns. A storage device stores a first phase time delay that corresponds to the sampling time of one of the selected first phase test patterns. The comparator then compares each of the subsequent multiple phase test patterns to the second phase sync detect pattern to determine if any are equivalent to the second phase sync detect pattern and designates one or more specific second phase test patterns as the selected second phase test patterns. The storage device then stores a second phase time delay that corresponds to the sampling time of one of the selected second phase test patterns. In a preferred embodiment, the first and second storage device includes a set of M bit shift registers wherein M is equal to the number of bits in the phase sync detect pattern. Furthermore, the comparator preferably is comprised of storage registers for the multiple phase test patterns which are stored and compared to the first phase sync detect pattern, then the second phase sync detect pattern to determine if any of the multiple phase test patterns are equivalent to the first then second phase sync detect patterns and designate optimized equivalents as selected phase test patterns. Since the delay or skew associated with the data streams is unknown, either of the first and second phase sync detect patterns might be detected during either the high or low portion or phase of the clock. To allow the interface to operate with skews of more than one half clock cycle, the interface looks for the first and second phase sync detect patterns during both halves of the clock cycle.

In accordance with the above discussed embodiment, after a predetermined number of clock cycles, the sync multiplexer cycles the sync detect line through each of the N+1 data lines such that an associated first phase time delay and an associated second phase time delay are determined and stored for each of the N+1 data lines. The sampler samples each of the N data streams based upon the associated first phase time delay and based upon the associated second phase time delay such that the coherency of the bi-phase data in the N data streams is maintained between the transmitting device and the receiving device. In an especially preferred embodiment, clock buffers are positioned between the clock line and the N+1 sampling devices in such a manner that the sampling devices sample the N+1 data streams at the associated first phase and second phase time delays for the respective data lines. An order multiplexer on the receiving interface separates the data stream containing the sync detect pattern from the data streams containing data and provides the data streams to the receiving device.

In an especially preferred embodiment of the above described interface, the comparator further includes a selection device for selecting one equivalent first phase test pattern as the optimal selected first phase test pattern based upon predetermined criteria when more than one of the multiple first phase test patterns are equivalent to the first phase sync detect pattern. Likewise, the comparator further includes a second selection device for selecting one equivalent second phase test pattern as the optimal selected second phase test pattern based upon predetermined criteria when more than one of the multiple second phase test patterns are equivalent to the second phase sync detect pattern.

The interface of the present invention improves upon the prior art by maintaining the coherency of data during a high speed parallel transmission without requiring complex circuitry. The interface basically only requires a number of multiplexers, comparators, samplers and latches along with a transmission clock. Thus, the interface is cost effective to implement with off the shelf generic library elements and extremely effective in correcting for phase delays.

Yet another embodiment of the present invention incorporates a bit delay detecting and correcting device in the interface. Bit delay detecting and correcting device includes a counter for determining the number of clock cycles that pass between reception of the sync detect pattern on a data line designated as a reference data line and reception of the sync detect pattern on successive data lines. A predetermined number of clock cycles is stored in the device corresponding to the time delay between the transmission of the phase sync detect pattern on adjacent data lines. A skew detector compares the predetermined number of clock cycles to the determined (counted) number of clock cycles between reception of the sync detect pattern on the reference data line and reception of the sync detect pattern on the next data line designated as the sync test line. Thus, the skew detector determines a data skew between the reference data line and the current data line designated as the sync test line. The skew detector determines the data skew for each data line with respect to the reference data line. A bit delay compensator then skew corrects data received on each of the N+1 data lines by the data skew between the respective lines of the N+1 data lines to produce skew corrected data. The skew corrected data is then provided to the receiving device.

The present invention further envisions a method for maintaining the coherency of bi-phase data being transmitted in parallel between a transmitting device and a receiving device wherein the data comprises sets of X bits of data being transmitted in N data streams on a N+1 data lines, a sync line and a clock line. The method includes generating a sync signal including a predetermined first half sync detect pattern and a predetermined second half sync detect pattern at the transmitting device. A clock generator produces a bi-phase clock signal including a first half phase clock period and a second half phase clock period at the transmitting device. The bi-phase clock signal is transmitted between the transmitting device and the receiving device. One of the N+1 data lines is designated as a sync test line. The sync signal including the first half sync detect pattern and the second half sync detect pattern is transmitted to the receiving device on the sync test line. Each of the N data streams is transmitted to the receiving device on the remaining N of N+1 data lines. The received sync signal is sampled at multiple sampling times to produce multiple phase test data sets. The multiple test data sets are compared to the first half sync detect pattern to determine which of the multiple test data sets corresponds to the first half sync detect pattern. A first time delay that corresponds to the sampling time of one of the multiple test data sets that matches the first half sync detect pattern is stored. The multiple test data sets are compared to the second half sync detect pattern for each of the multiple data sets to determine which of the multiple test sampled data sets corresponds to the second half sync detect pattern. A second time delay is stored that corresponds to the sampling time of one of the multiple test data sets that matches the second half sync detect pattern. Future data streams received on the data line designated as the sync test line are sampled at the first time delay and future data streams received during the second clock phase period are sampled at the second time delay. The N+1 data lines are cycled through by designating the next of the N+1 data lines as the sync test line and calculating an associated first time delay and associated second time delay for each of the N+1 data lines. Future data streams on each of the N+1 data lines are then sampled at the associated first delay during and the associated second delay.

A predetermined number of clock cycles pass between transmission of the sync detect pattern on a data line designated as the sync test line and transmission of the sync detect pattern on a next data line designated as the sync test line. A first data line designated as the sync test line is further designated as a data skew reference line. The number of clock cycles between reception of the sync detect pattern on the data skew reference line and reception of the sync detect pattern on a next data line designated as the sync test line is counted. The counted number of clock cycles between reception of the sync detect pattern on the data skew reference line and the data line designated as the next sync test line is compared to a predetermined number of clock cycles, which corresponds to the delay between transmission of the sync detect pattern on the data skew reference line and transmission of the sync detect pattern on the next data line designated as the sync test line. This comparison determines a data skew value of the data line with respect to the data skew reference line. A data skew value is determined for each of the N+1 data lines with respect to the data skew reference line. Data skew between the data streams is then corrected by time shifting the data streams with respect to the data stream on the data skew reference line based upon the data skew values.

In accordance with the above described method, an unlock condition is indicated if a first phase test data set that is equivalent to the first half sync detect pattern or a second phase test data set that is equivalent to the second half sync detect pattern is not located for any one of the N+1 data lines during consecutive cycling of the sync test line through the N+1 data lines. Conversely, a lock condition is indicated if a first phase test data set that is equivalent to the first half sync detect pattern and a second phase test data set that is equivalent to the second half sync detect pattern are located for each of the N+1 data lines for two consecutive cycles of the sync test line though all N+1 data lines.

Having summarized various aspects of the invention, the invention will now be described in greater detail with reference to the following figures wherein similar reference numerals designate the similar features throughout the figures.

### BRIEF DESCRIPTION OF THE DRAWINGS

FIG. 1 depicts a flow chart of a preferred method of maintaining the coherency of multiple data streams being transferred at high speeds between a transmitting device and a receiving device on nine differential data lines;

FIG. 2 depicts a flow chart of a method of the present invention that corrects for line delays of multiple clock cycles;

FIG. 3 depicts a flow chart of an interface for transmitting multiple parallel data streams in accordance with a preferred embodiment of the invention;

FIG. 4 depicts a preferred multiplexer circuit for sequencing the sync detect pattern through the data lines;

FIG. 5 depicts a functional diagram of an especially preferred embodiment of the present invention which corrects for both phase delays and data skews of multiple clock cycles due to delays in the data lines; and

FIG. 6 depicts a preferred receiving circuit in accordance with the present invention.

### DETAILED DESCRIPTION OF THE INVENTION

The goal of this invention is to maintain data alignment of multiple data signals being transmitted in parallel at high-speed data rates. The approach set forth briefly above and in more detail below, lies in adjusting the selected sampling times and skewing the received data streams such that the bits in the data streams maintain their relative positions.

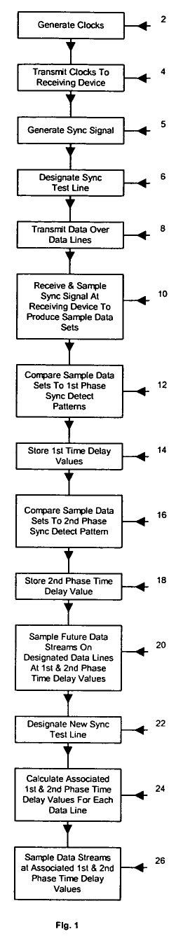

Referring now to a FIG. 1, a preferred method of maintaining the coherency of multiple data streams being transferred at high speeds between a transmitting device and a receiving device on nine differential data lines is depicted. High speed data transfers between a transmitting device and a receiving device are preferably accomplished with differential data lines. The method begins with the generation of a clock signal at the transmitting device as shown in block 2. In the preferred method, a bi-phase clock signal is generated in block 2 that includes a first phase clock period and a second phase clock period. In block 4, the generated clock signal is transmitted to the receiving device on a clock line. In the context of this invention, ‘high speed’ indicates data rates in excess of about 1 gigabit per second for each parallel signal. When passing data in a bi-phase manner, a supporting clock of one half that frequency is required. Thus, for a 1 GHz signal, a 500 MHz clock would be required.

To achieve synchronization, a predetermined serial sync detect pattern needs to be transmitted during each half of successive transmitted clock periods. Then, a sub interval clock phase, which will successfully extract the sync detect pattern from the data lines can be determined. The sync signal is generated at the transmitting device in block 5. The sync signal includes a predetermined first phase sync detect pattern and second phase sync detect pattern. Furthermore, the first phase sync detect pattern is preferably the inverse of the second phase sync detect pattern. Once the sync signal has been generated, one of the differential data lines across which the multiple data streams will be transmitted is designated as a sync detect line in block 6. The multiple data streams are then transmitted to the receiving device simultaneously with the sync signal across the data lines in block 8. Because the sync detect signal is transmitted simultaneously with the data streams, one extra differential data line is required. Thus, N+1 differential data lines are needed to transmit N data streams between the receiving and transmitting device.

In block 10, the received sync signal is sampled at the receiving device at multiple sampling times to produce multiple test data sets. The number of sample points per clock cycle is evenly spread across each clock period. In a preferred embodiment, the received sync signal and the data streams are sampled multiple times within each half clock period. The sync signal samples are examined such that all test data sets are produced in the time required to transmit the first and second phase sync detect patterns. The data line containing the sync detect pattern could be sampled at a higher rate than the data streams, however, manipulating the sampling rates of the data lines when transmitting the sync detect pattern requires additional circuitry. Thus, sampling all of the data lines at the higher rate and simply ignoring the extra data samples from the data streams is more cost effective.

After sampling, the multiple test data sets sampled are compared to the first phase sync detect pattern in block 12 to determine if any of the multiple test data sets sampled match the first half sync detect pattern. If any of the multiple test data sets match the first phase sync detect pattern, the optimal phase time delay that corresponds to the sampling time of the matching test data set is stored in block 14.

In similar fashion to that described above for the first phase data, each of the multiple test data sets sampled are compared to the second phase sync detect pattern to determine if any of the multiple test data sets sampled match the second phase sync detect pattern in block 16. If any of the multiple test data sets match the second phase sync detect pattern, a second phase time delay is stored that corresponds to the optimal sampling time of the multiple test data sets that match the second phase sync detect pattern in block 18. As previously discussed, a variety of criteria can be used to select a particular or optimal phase delay if multiple phase delays correctly extract the sync detect pattern.

Once a first phase time delay and a second phase time delay are stored for a particular differential pair of data lines, future data streams received on that pair of data lines are sampled at a time corresponding to the first phase time delay and the second phase time delay, as indicated at block 20. Sampling at the first and second phase time delays corrects delays in the reception of the data due to the physical aspects of the transfer path. In addition, the above discussed procedure is repeated by cycling through the N+1 data lines by designating a new one of the successive N+1 data lines as the sync test line after a predetermined number of clock cycles, as indicated at block 22. An associated first phase time delay and an associated second phase time delay are established for each of the N+1 data lines in block 24 and future data streams received on each of the N+1 data lines are sampled at the first and second phase delays associated with the particular line during the respective first and second clock phases as shown in block 26.

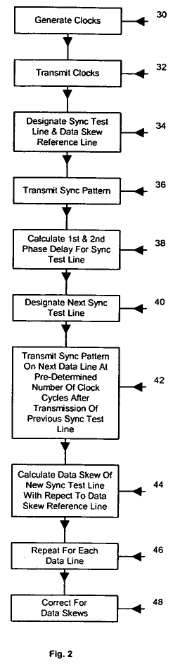

Referring now to FIG. 2, a second method of the present invention wherein the method can correct for delays of multiple clock cycles is depicted in block form. The method begins similar to that of FIG. 1 with the generation of a clock signal in block 30. The clock signal is transmitted to the receiving device in block 32. One of the data lines is then designated as the first sync test line at block 34 and the sync detect pattern is transmitted to the receiving device, as indicated at block 36. A first and second phase delay are established for the sync test line in block 38 as discussed in more detail above. The next data line is then sequentially designated as the sync test line, block 40. The sync detect pattern is transmitted such that it should appear on the next sync line a predetermined number of clock cycles later in block 42. The timing of the reception of the sync detect pattern is used to calculate any data skew in the second data stream with respect to the first data stream as shown in block 44. The above described process is repeated until a first and second phase delay and whole bit data skew values are determined for each data line, block 46. The data skew between the data streams is then skew corrected for by skewing the data streams in accordance with their calculated skew with respect to the skew reference line in block 48.

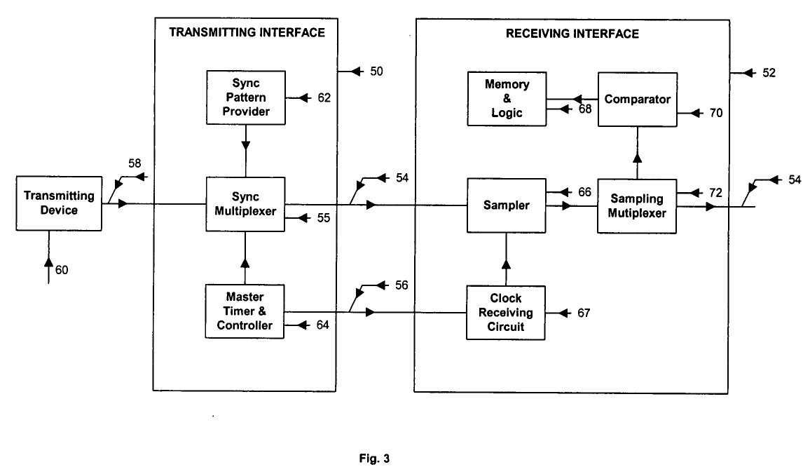

Referring now to FIG. 3, a block diagram of a preferred interface for transmitting multiple parallel data streams in accordance with the present invention is shown. The interface includes a transmitting interface 50 and a receiving interface 52. The transmitting interface 50 and the receiving interface 52 communicate a number (N) of parallel data streams over N+1 data lines 54 and a clock signal over a clock line 56. A sync test signal is transmitted through each of the data lines 54 while the data streams are being transmitted over the remaining data lines. Thus, the interface requires a number of data lines 54 equal to the number of data streams plus one.

The transmitting interface 50 has a sync multiplexer 55 that receives the multiple data streams 58 from a transmitting device 60. A master timer and controller 64 provides a bi-phase clock signal to the receiving interface 52 on the clock line 56 and controls the timing of the transmitting interface 50. A sync pattern provider 62 also located in the transmitting interface 50 provides a predetermined sync detect pattern that includes a first phase sync detect pattern and a second phase sync detect pattern to the sync multiplexer 55. The sync multiplexer 55 multiplexes the multiple data streams 58 and the sync detect pattern from the sync pattern provider 62 onto the nine data lines 54 under the control of the master timer and controller 64. The master timer and controller 64 designates one of the data lines as a sync detect line and the remaining data lines as data transmitting lines by controlling the sync multiplexer 55.

The receiving interface 52 has nine samplers 66 which sample the received data streams and the sync detect pattern on the nine data lines 54. A clock receiving circuit 67 receives the clock signal on the clock line 56 and provides clock signals to the samplers 66. The data lines 54 are sampled at multiple intervals during the clock period. For this example, we will assume that ten samples are taken by the samplers 66 during each clock cycle. The sampled values received on the data line designated as the sync test line are stored in a storage and logic circuit 68 at the receiving interface 52. To begin the method, the receiving interface 52 dwells or waits until the sync test pattern is detected on a designated line and then follows the sync detect pattern as it is sequenced through the data lines in a predetermined order. Once the sync detect pattern has been successfully detected twice sequentially on all lines, a synchronization lock has been achieved. The memory and logic circuit 68 arranges the samples such that the corresponding samples for each clock cycle are grouped together. Thus, the multiple samples taken during the first clock cycle are grouped and examined followed by those samples taken during the next clock cycle. Thus, each group corresponds to sampling over a clock cycle. Furthermore, the groups correspond to samples taken during each phase of the clock period. The number of groups for each phase of the clock depends upon the duty cycle of the clock signal and the sampling interval of the samplers 66.

The memory and logic circuit 68 provides the sampled data groups to a comparator 70. The comparator 70 examines the individual data groups to determine whether any of the data groups match the sync detect pattern. The sync detect pattern is preferably hardwired into the comparator 70. However, it will be readily appreciated that there are a number of ways to provide the comparator 70 with the predetermined sync detect pattern. Once the comparator 70 has determined a sampling time which accurately extracts the sync detect pattern for both the first and second phases of the clock cycle, the comparator 70 prompts a sampling multiplexer 72 to multiplex the sampling time associated with the match to the samplers 66 associated with the sync test line when the sync test line is next designated as a data stream line by the master timer and controller 64. The master timer and controller 64 designates each of the data lines 54 as a sync test line until a sampling time that successfully extracts the sync detect pattern has been determined for each data line 54. When data is being transmitted, the cycling preferably continues such that the sampling times are continuously being updated to accommodate for changes in the delays associated with the data lines 54.

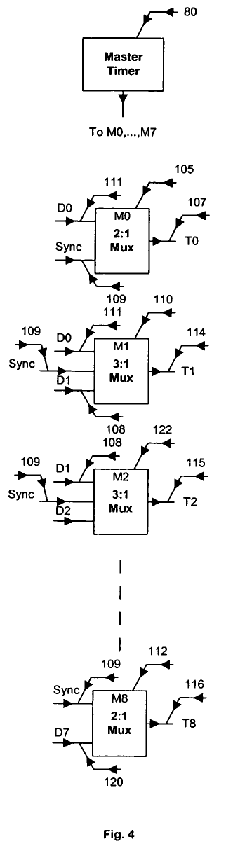

FIG. 4 depicts a preferred multiplexer circuit for sequencing a sync test line 109 and eight data streams D0-D7 onto nine transmission lines T0-T8. Nine transmission lines T0-T8 illustrate one simple form of a multiple transmission line interface, however, the number of transmission lines is only intended to be illustrative of multiple transmission lines. A first 2 to 1 multiplexer 105 alternatively multiplexes a first data stream 111 and the sync test line 109 onto a first transmission line 107 in response to a master timer and controller 64. The master timer and controller 64 preferably first directs multiplexer M0 105 to multiplex the sync test line 109 onto transmission line T0 for a predetermined number of clock cycles. Following this, the master timer and controller 64 sequentially controls multiplexers M1 110 through M8 112 such that data streams D0 111 through D7 120 are respectively multiplexed onto transmission lines T1 114 through T8 116. Once the predetermined number of clock cycles have passed, the master timer and controller 64 controls the multiplexer M0 105 such that data stream D0 111 is multiplexed on transmission line T0 107. The master timer and controller 64 further controls multiplexer M1 110 such that the sync test line 109 is multiplexed onto transmission line T1 114. The remaining data streams D1 108 through D7 120 are then multiplexed by multiplexers M2 122 through M8 112 onto transmission lines T2 115 through T8 116. The process is sequentially repeated during each predetermined number of clock cycles until the sync test line 109 has been sequenced through each of the transmission lines T0 107 through T8 116. Thus, the multiplexer circuit of FIG. 4 functions to sequence the sync test pattern transmitted on the sync test line 109 through each of the transmission lines T0 107 through T8 116.

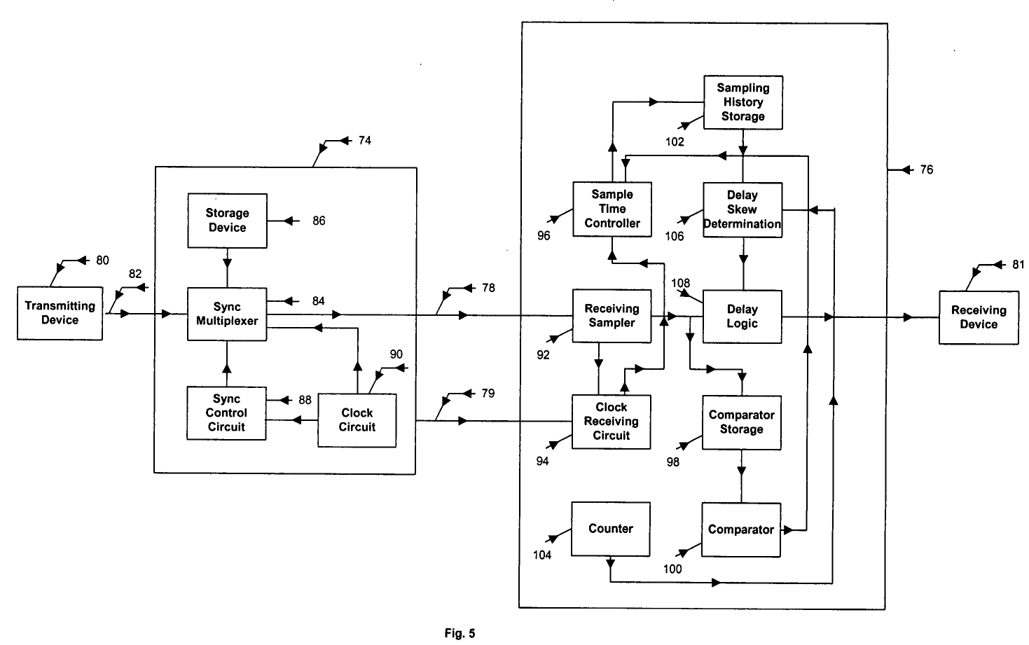

Referring now to FIG. 5, a functional diagram of an especially preferred embodiment of the present invention which corrects for both phase delays and data skews of multiple clock cycles due to delays in the data lines 78 is shown. Like the interface of FIG. 3, the embodiment of FIG. 5 includes a transmitting interface 74 and a receiving interface 76. A sync multiplexer 84 in the transmitting interface 74 receives a number, N, of data streams 82 from a transmitting device 80. The sync multiplexer 84 also receives a sync detect pattern from a storage device 86 and a clock signal from clock circuit 90. The sync multiplexer 84 multiplexes the sync detect pattern and the N data streams 82 onto the N+1 data lines under the control of a sync control circuit 88 and a clock circuit 90. The clock circuit 90 transmits the clock signal from the transmitting interface 74 to the receiving interface 76 on clock line 79.

The sync control circuit 88 controls the sync multiplexer 84 to designate one of the N+1 data lines 78 as a sync line. Preferably, the control circuit 88 sequences through the N+1 data lines 78 designating each one as the sync line for a predetermined number of clock cycles. The sync control circuit 88 then instructs the sync multiplexer 84 to couple the sync detect pattern onto a data line 78 designated as the sync line and the N data streams 82 onto the remaining N data lines 78 of the N+1 data lines.

At the receiving interface 76, N+1 receiving samplers 92 receive and sample the N data streams and the sync detect pattern on the N+1 data lines 78. A clock receiving circuit 94 at the receiving interface 76 receives the clock signal on the clock line 80. The receiving samplers 92 preferably sample the sync detect pattern and data streams on the N+1 data lines at a rate that is higher than the clock rate. In an especially preferred embodiment, the clock signal is a bi-phase clock signal and the receiving sampler 92 is sampling the sync detect pattern samples multiple times during each phase of the clock signal. The receiving interface 76 determines which received sample 92 of the sync detect pattern is in accordance with a predetermined order in which the sync detect pattern is sequenced through the data lines. The interface 76 dwells on one line 78 until the sync detect pattern is detected and then it follows the sync detect pattern through the remaining lines in the predetermined order. Once the sync detect pattern is detected on each line 78 twice sequentially, a sync lock has been achieved.

The receiving samplers 92 sample signals on the data lines 78 under the control of a sampling time controller 96. In particular, the receiving sampler 92 that receives the sync detect pattern on the data line 78 designated as the sync line samples the sync detect pattern at multiple spaced intervals during each phase of the clock signal. These sampled values are then stored in comparator storage device 98 such that samples taken during the same sampling time of the clock signal are related into a data set. The comparator storage device 98 provides these data sets to a comparator 100 such that each set of data corresponding to a sampling time is compared to the predetermined sync detect pattern. If the comparator 100 determines that a data set corresponding to samples taken match the first phase sync detect pattern, the comparator 100 instructs the sampling time controller 96 to sample future data streams received on the particular data line from which the data set was obtained at the sampling time corresponding to the matched data set.

At this point, it is necessary to address the situation where more than one of the sampling data sets corresponds to the sync detect pattern. For example, assume a clock rate of 500 MHz for a bi-phase data rate of 1 GHz. Furthermore, assume the receiving samplers 92 are sampling at a rate of ten evenly spaced times per clock cycle. Thus, the receiving samplers 92 are sampling the received signals every 200 ps, 1 sec/(500,000,000 cycles times 10 samples per cycle)=200 ps per sample. Thus, the sampling times are as set forth below in Table 1.

TABLE 1

| Phase Sample | Time in picoseconds |
|---|---|
| 0 | 0 |
| 1 | 200 |
| 2 | 400 |
| 3 | 600 |
| 4 | 800 |
| 5 | 1000 |
| 6 | 1200 |
| 7 | 1400 |
| 8 | 1600 |
| 9 | 1800 |

Now suppose that the comparator 100 determines that the sample data sets taken during sampling times 4, 5 and 6 match the first phase sync detect pattern. The question then becomes at which one of the sampling times should future data streams on the data line be sampled. A wide variety of different logic schemes could be used to select a particular sampling time from a set of sampling times which successfully extract the sync detect pattern. However, in the preferred embodiment, the sampling time controller 96 selects the sampling time in the middle of a set of multiple consecutive matches. Thus, the sampling timing controller 96 would select sampling time 5 in the above example.

Now suppose that sampling times 4 and 5 produce matches to the first phase sync detect pattern. One way of determining which sampling time to select is to examine previous sampling time matches from prior sync detect tests. Thus, if matches were obtained for sampling times 4, 5 and 6 during the prior sync test and matches were obtained only for sampling times 4 and 5 during the most recent sync test, the preferred interface would select sampling time 4, because the indication is that the phase drift is towards the earlier sampling times. In embodiments which select a sampling time based upon past determinations, a sampling history storage 102 is incorporated in the receiving interface 76 for saving past sampling data. Thus, the preferred rules for selecting from multiple sampling time matches can be summarized as selecting the center sampling time if an odd number of matches occur and examining the past sampling history to pick between two possible matches if only 2 sampling time matches occur.

The embodiment of FIG. 5 also includes a counter 104. A predetermined number of clock cycles, for example 64 clock cycles, should pass between the reception of the first bit of the sync detect pattern on the first sync line and reception of the first bit of the sync detect pattern on the next data line designated as the sync line. The counter 104 keeps a count of the number of clock cycles that pass between reception of the first bit of the sync detect pattern on the sync line and the reception of the first bit of the sync detect pattern on the next data line designated as the sync test line. The counter 104 then sends this count information to a data skew detector 106. The data skew detector 106 designates one of the data lines 78 as a reference data line. The data skew detector 106 then determines a data skew of the remaining data lines 78 with respect to the reference data line. For example, suppose the data skew detector 106 is programmed or hardwired to know that a predetermined 64 clock cycles pass between transmission of the sync detect pattern on a first data line 78 and transmission of the sync detect pattern on the next data line designated as the sync line. If the information from the counter 104 indicates that 65 clock cycles have passed between the reception of the sync detect pattern on the first data line and its reception on the second data line, the data skew detector determines that the data on the second line is skewed one data bit with respect to the reference line. By repeating the above described procedure for each data line, the data skew detector 106 determines a data skew of each of the data lines with respect to the data line designated as the reference data line. This data skew between the incoming data streams is corrected with delay logic 108 that delays the data streams under the control of the data skew detector 106. The skew corrected data is then provided to the receiving device 81.

In an alternative embodiment, the counter 104 is a modulo counter which counts a number of sub intervals that pass between reception of the sync detect pattern on the data lines such that both phase delays and data skews may be corrected by the modulo counter 104. For example, suppose the modulo counter 104 counts 10 times for each clock cycle and the data lines are sampled at 10 different sub intervals per clock style. Then if the sync detect pattern is supposed to appear on a designated line 640 sub intervals after appearing on the reference line and the sync detect pattern actually appears on the designated line after 651 sub intervals, then the designated line is skewed by 11 sub intervals with respect to the reference line.

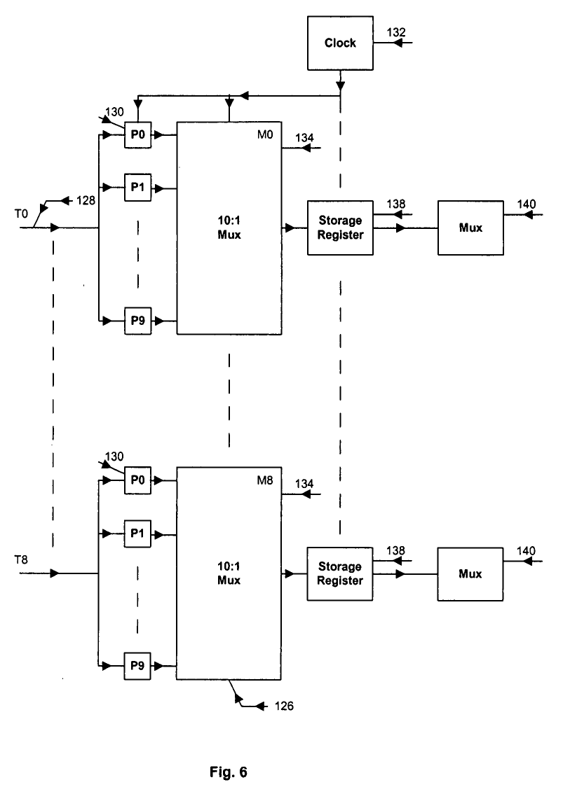

A preferred receiving circuit 126 for receiving eight data streams and a sync test pattern on nine transmission lines in accordance with the present invention is shown in FIG. 6. Again, the number of transmission lines is only illustrative of multiple transmission lines. The receiving circuit 126 receives the nine transmission lines T0-T8 128 from a transmitting interface 74 such as that shown in FIG. 4. Each of the transmission lines 128 is received by an associated array of phase delay registers 130. The phase delay registers 130 are controlled by a clock circuit 132 such that each phase delay register P0-P9 130 samples the transmission signal received on its respective received transmission line T0-T8 128 at a different sampling time. Thus, the receiving circuit 126 of FIG. 6 is configured to sample each transmission line 128 at ten different phases delays. A respective ten to one multiplexer 134 receives the ten phase delayed versions of each transmitted signal received on T0-T8 128 from the associated phase delay registers 130 and selectively provides the phase delayed versions to an associated storage register 138. Thus, in response to the clock 132, each of the ten phase delayed versions of the transmission signal are multiplexed to the respective storage registers 138. The stored phased delayed versions of the transmitted signals can then be compared to the predetermined sync test pattern to determine which phase delay correctly extracts the sync detect pattern. Once the appropriate phase delay has been determined, the multiplexer 134 is configured to receive data from the phase delay storage register 130 which correctly extracts the sync test pattern. Thus, the receiving circuit of FIG. 6 allows the receiver to correct for any phase delays associated with the transmission lines 128. The output of the storage registers 138 may be multiplexed through of set of multiplexers 140 to direct the data to the appropriate circuitry depending upon whether the received data represents the sync detect pattern or a data stream in a manner similar to that shown in FIG. 4.

In view of the above explanation of the particular features of the present invention, it will be readily appreciated by one skilled in the art that the present invention can be usefully employed in a wide variety of embodiments. While certain embodiments have been disclosed and discussed above, the embodiments are intended to be exemplary only and not limiting of the present invention. The appropriate scope of the invention is defined by the claims set forth below.

1. A method for passing a multiple bit wide data stream between a receiving device and a transmitting device on multiple data lines, the method of comprising:
producing a clock signal at the transmitting device and transmitting said clock signal to said receiving device on a clock line;
transmitting a predetermined synchronization pattern from said transmitting device to said receiving device on each of said multiple data lines to determine a sub interval clock phase for each data line that will successfully compensate for phase delays associated with said data lines and extract the synchronization pattern from each of said multiple data lines; and
extracting data from each of said multiple data lines at said sub interval clock phase determined for each of said multiple data lines to compensate for said phase delays.

2. The method of claim 1 further comprising determining a bit delay between a received data stream on one of said multiple data lines designated as a reference delay line and a received data stream on each of said multiple data lines not designated as said reference delay line and skew correcting the received data streams according to their respective bit delays such that said data streams are coherently transferred between said transmitting device and said receiving device.

3. The method of claim 1 wherein transmitting said clock signal on said clock line further comprises transmitting said clock signal on a differential set of clock lines, and wherein said multiple data lines further comprise multiple differential sets of data lines and wherein said data is transmitted in a bi-phase manner such that even bits are transmitted during high clock output states and odd bits are transmitted during low clock output states.

4. The method of claim 3 wherein determining a sub interval clock phase further comprises determining a first sub interval clock phase for a high clock output state half cycle and determining a second sub interval clock phase for a low clock output state half cycle and wherein sampling at said sub interval clock phase further comprises sampling at said first sub interval clock phase during high clock output state half cycles and sampling at said second sub interval clock phase during low clock output state half cycles.

5. An interface for maintaining the coherency of data in N data streams being transmitted between a transmitting device and receiving device that includes a transmitting interface and a receiving interface, said interface comprising:
a sync pattern provider located on said transmitting device interface for providing a predetermined sync detect pattern;
a clock generator for generating a clock signal;
a sync multiplexer located at said transmitting interface for receiving said N data streams from said transmitting device and said sync detect pattern from said sync pattern provider and selectively multiplexing said sync detect pattern and said N data streams onto N+1 data lines;
a test line controller designating one of said N+1 data lines as a sync detect line and designating N of said N+1 data lines as data transmitting lines so that said sync multiplexer transmits said sync detect pattern to said receiving interface on a selected sync detect line, and wherein said sync multiplexer transmits said N data streams to said receiving interface on each one of said N+1 data lines not selected as said sync detect line;
a clock receiving circuit positioned at said receiving interface for receiving said clock;
N+1 samplers positioned at said receiving device interface for receiving and sampling said N data streams and said sync detect pattern on said N+1 data lines and providing said data streams to said receiving interface wherein said samplers sample said sync detect pattern at multiple phase time delays to produce multiple phase test patterns;
comparators for comparing each one of said multiple phase test patterns to said phase sync detect pattern to determine if any of said multiple phase test patterns are equivalent to said phase sync detect pattern and designating such equivalent phase test patterns as selected phase test patterns;
storage devices for storing a phase time delay corresponding to the phase time delay of one of said selected phase test patterns;
wherein during a predetermined number of clock cycles said sync multiplexer cycles said sync detect line through each one of said N+1 data lines such that an associated phase time delay is determined and stored for each of said N+1 data lines and wherein said samplers sample each of said N data streams based upon said associated phase time.

6. The interface of claim 5 further comprising:
said sync pattern provider providing a predetermined sync detect pattern having a first phase sync detect pattern and a second phase sync detect pattern;
said clock generator generating a clock signal having a first clock phase period and a second clock phase period at said transmitting device;
said N+1 samplers sampling said sync detect pattern at multiple first phase time delays during said first clock phase to produce multiple first phase test patterns and sampling said sync detect pattern at multiple second phase time delays during said second clock phase to produce multiple second phase test patterns;
said comparators comprising:
comparators for comparing each one of said multiple first phase test patterns to said first phase sync detect pattern to determine if any of said multiple first phase test patterns are equivalent to said first phase sync detect pattern and designating such equivalent first phase test patterns as selected first phase test patterns; and
the same comparators for comparing each one of said multiple second phase test patterns to said second phase sync detect pattern to determine if any of said multiple second phase test patterns are equivalent to said second phase sync detect pattern and designating such equivalent second phase test patterns as selected second phase test patterns;
said storage devices storing first and second phase time delays corresponding respectively to the phase time delays of one of said selected first and second phase test patterns;
during a predetermined number of clock cycles, said sync multiplexer cycling said sync detect line through each one of said N+1 data lines such that an associated first phase time delay and an associated second phase time delay are determined and stored for each of said N+1 data lines and wherein said samplers extract data from each of said N data streams based upon said associated first phase time delay during said first clock phase and based upon said associated second phase time delay during said second clock phase.

7. The interface of claim 6 wherein said comparators further comprise controllers for selecting one equivalent first phase test pattern as an optimal selected first phase test pattern based upon predetermined criteria when more than one of said multiple first phase test patterns are equivalent to said first phase sync detect pattern and wherein said comparators further comprise controllers for selecting one equivalent second phase test pattern as an optimal selected second phase test pattern based upon predetermined criteria when more than one of said multiple second phase test patterns are equivalent to said second phase sync detect pattern.

8. The interface of claim 5 wherein said sync pattern provider further comprises an M bit serial shift register that serially provides an M bit sync detect pattern to said sync multiplexer in response to said clock signal.

9. The interface of claim 6 wherein said storage devices further comprise N+1 sets of M shift registers wherein M is equal to a number of bits in said first phase sync detect pattern plus a number of bits in said second phase sync detect pattern and wherein said sets of M shift registers serially receive said first phase sync detect pattern and said second phase sync detect pattern from said N+1 data lines.

10. The interface of claim 5 wherein said N+1 samplers further comprise clock buffers positioned between said clock line and N+1 sampling devices such that said sampling devices sample the N data streams at the associated first and second phase time delays for the respective data lines.

11. The interface of claim 6 wherein said comparators further comprise comparing storage registers for storing said multiple sampled first phase test patterns and said multiple sampled second phase test patterns and comparators for comparing said stored multiple first and second phase test patterns to said predetermined first and second phase sync detect patterns to determine if any of said multiple first phase test patterns are equivalent to said first phase sync detect pattern and designating such equivalent first phase test patterns as selected first phase test patterns and to determine if any of said multiple second phase test patterns are equivalent to said second phase sync detect pattern and designating such equivalent second phase test patterns as selected second phase test patterns.

12. The interface of claim 5 further comprising an order multiplexer for separating said sync detect pattern from said data streams and providing said data streams to said receiving device.

13. The interface of claim 5 further comprising bit delay detecting and correcting devices, said bit delay detecting and correcting devices comprising:
a counter for determining a number of clock cycles that pass between reception of the sync detect pattern on a data line designated a reference data line and reception of the sync detect pattern on a next data line designated as the sync test line;
a skew detector for comparing a predetermined number of clock cycles that pass between transmission of the sync detect pattern on the reference data line and transmission of the sync detect pattern on the next data line to the determined number of clock cycles between reception of the sync detect pattern on the reference data line and the next data line designated as the sync test line to determine a data skew between the reference data line and the data line designated as the sync test line wherein said skew detector determines a data skew for each data line with respect to said reference data line; and
a bit delay compensator for skew correcting data received on each of said N+1 data lines by said data skew between said respective lines of said N+1 data lines to produce skew corrected data and providing said skew corrected data to said receiving device.

14. A method for maintaining the coherency of bi-phase data being transmitted in parallel between a transmitting device and a receiving device said data comprising sets of data bits being transmitted in N data streams on N+1 data lines, a sync line and a clock line, said method comprising:
generating a sync signal including a predetermined first half sync detect pattern and a predetermined second half sync detect pattern at said transmitting device;
producing a bi-phase clock signal including a first phase clock period and a second phase clock period at said transmitting device;
transmitting said bi-phase clock signal between said transmitting device and said receiving device;
designating one of said N+1 data lines as a sync test line;
transmitting said sync signal including said first half sync detect pattern and said second half sync detect pattern to said receiving device on said sync test line;
transmitting said each of said N data streams to said receiving device on a one of said N+1 data lines;
sampling said received sync signal at multiple sampling times to produce multiple first phase and second phase test data sets;
comparing said multiple test data sets to said first half sync detect pattern to determine which of said multiple test data sets sampled during said clock period corresponds to said first half sync detect pattern;
storing a phase time delay that corresponds to one of said multiple test data sets that corresponds to said first half sync detect pattern;
comparing said multiple test data sets to said second half sync detect pattern for each of said multiple data sets to determine which of said multiple test data sets sampled during said clock period corresponds to said second half sync detect pattern;
storing a second phase time delay that corresponds to one of said multiple test data sets that corresponds to said second half sync detect pattern;
sampling future data streams received on said data line designated as said sync test line at sampling times based on said stored first and second phase time delays; and
cycling through said N+1 data lines by designating a new one of said N+1 data lines as said sync test line after a predetermined number of clock cycles and calculating associated first and second phase time delays respectively for first phase clock periods and second phase clock periods for each of said N+1 data lines and sampling future data streams on each of said N+1 data lines at sampling times based on said associated first and second phase delays during each said clock period.

15. The method of claim 14 further comprising indicating a lock condition if a first phase test data set that is equivalent to said first half sync detect phase and a second phase test data set that is equivalent to said second half sync detect pattern is located for each of said N+1 data lines for two consecutive cycles of the sync test line though said N+1 data lines.

16. The method of claim 14 further comprising indicating an unlock condition if a first phase test data set that is equivalent to said first half sync detect pattern and a second phase test data set that is equivalent to said second half sync detect pattern are not located for all of said N+1 data lines during any consecutive cycling of the sync test line through said N+1 data lines.

17. The method of claim 14 wherein sampling said received sync signal during said first phase clock period and said second phase clock period at multiple sampling times to produce multiple first phase and second phase test data sets further comprises sampling said received sync signal at a higher rate than a data rate of said data streams such that all of said multiple first phase and second phase test data sets are produced in the time required to transmit said first and second half sync detect patterns.

18. The method of claim 14 wherein a predetermined number of clock cycles pass between transmission of the sync detect pattern on a data line designated as the sync test line and transmission of the sync detect pattern on a next data line designated as the sync test line, said method further comprising:
designating a data line designated as the sync test line as a data skew reference line;
counting the number of clock cycles between reception of said sync detect pattern on said data skew reference line and reception of said sync detect pattern on a next data line designated as the sync test line;
comparing the counted number of clock cycles between reception of the sync detect pattern on the data skew reference line and the data line designated as the next sync test line to a predetermined number of clock cycles between transmission of the sync detect pattern on said data skew reference line and said data line designated as the next sync test line to determine a data skew value of said data line with respect to said data skew reference line;
determining a data skew value for each of said N+1 data lines with respect to said data skew reference line; and
correcting for data skew between said data streams by time shifting said data streams with respect to said data stream on said data skew reference line based upon said data skew values.
